(19) United States
(12) Patent Application Publication
(10) Pub. No.: US 2017/0139974 A1
(43) Pub. Date: May 18, 2017

(54) SYSTEM AND METHOD FOR EXPLORING AND VISUALIZING MULTIDIMENSIONAL AND HIERARCHICAL DATA

(71) Applicant: General Electric Company, Schenectady, NY (US)

(72) Inventors: Waqas Javed, San Ramon, CA (US); Sharoda Aurushi Paul, San Ramon, CA (US); Bo Yu, San Ramon, CA (US); Seunghyun Lee, San Ramon, CA (US); Paulo Pereira, San Ramon, CA (US)

(21) Appl. No.: 14/940,522

(22) Filed: Nov. 13, 2015

(51) Int. Cl. G06F 17/30; G06F 3/0481

(52) U.S. Cl. CPC G06F 17/30371; G06F 17/30383; G06F 17/30451; G06F 3/04817; G06F 17/30598

(57) ABSTRACT

Some embodiments are associated with a big data pull infrastructure adapted to provide a substantial number of electronic files, originating from a plurality of data sources, to be ingested and validated. A visualization system may collect meta information associated with the electronic files received from the big data pull infrastructure. According to some embodiments, a hierarchical, multidimensional view of the meta data associated with the electronic files may be established. Moreover, the hierarchical, multidimensional view of the meta data may be rendered by the visualization system as nested icons, at least one icon being represented via a plurality of unique visual characteristics indicating: (i) data that has not been ingested, (ii) data that has been ingested but not yet validated, and (iii) data that has been ingested and validated.

### BACKGROUND

The invention relates generally to big data displays and more particularly to systems and methods to provide visualization of big data.

An enterprise may be able to access substantial amounts of data. For example, an enterprise operating several businesses may constantly be updating financial information (e.g., sales, profits, outstanding purchase orders, etc.). It can be difficult, however, for a person to look at the data and understand what the information means (e.g., a person looking at tens of thousands parameter values may find it difficult to identify trends or correlations within the data). Moreover, client platforms, such as personal computers executing browsers, smartphone applications, etc. may not typically present large quantities of data in an understandable format. For example, a spreadsheet containing columns of numbers may make it difficult for a manager or Information Technology (“IT”) specialist to make comparisons, especially when there are a large number of businesses and/or parameters to be considered. It would therefore be desirable to facilitate a visualization of big data in such a way so as to improve a person's ability to interpret the big data efficiently and/or accurately.

### BRIEF DESCRIPTION

Some embodiments are associated with a big data pull infrastructure adapted to provide a substantial number of electronic files, originating from a plurality of data sources, to be ingested and validated. A visualization system may collect meta information associated with the electronic files received from the big data pull infrastructure. According to some embodiments, a hierarchical, multidimensional view of the meta data associated with the electronic files may be established. Moreover, the hierarchical, multidimensional view of the meta data may be rendered by the visualization system as nested icons, at least one icon being represented via a plurality of unique visual characteristics indicating: (i) data that has not been ingested, (ii) data that has been ingested but not yet validated, and (iii) data that has been ingested and validated.

Other embodiments may be associated with a big data pull infrastructure adapted to provide a substantial number of electronic files, originating from a plurality of data sources. A visualization system may collect meta information associated with the electronic files received from the big data pull infrastructure. According to some embodiments, a data flow view is rendered graphically indicating flows of information from data sources to data destinations. Moreover, a data exploration view may be rendered to graphically indicate a plurality of category icons, each icon representing a different type of data category, wherein nested sub-category icons are displayed within each category icon.

Other embodiments are associated with systems and/or computer-readable medium storing instructions to perform any of the methods described herein.

### DRAWINGS

FIG. 1 is a block diagram of a system that may be associated with any of the embodiments described herein.

FIG. 2 is a flow chart of a method in accordance with some embodiments.

FIG. 3 illustrates a visualization display according to some embodiments.

FIG. 4 illustrates visual characteristics on a tablet display in accordance with some embodiments.

FIG. 5 illustrates a visualization display with a legend according to some embodiments.

FIG. 6 illustrates a visualization display including more detailed parent enterprise-level information in accordance with some embodiments.

FIG. 7 illustrates a visualization display including more detailed child unit-level information according to some embodiments.

FIG. 8 is a block diagram of a system architecture that may be associated with any of the embodiments described herein.

FIG. 9 illustrates a visualization display including a data flow view according to some embodiments.

FIG. 10 illustrates a visualization display including a data exploration view in accordance with some embodiments.

FIG. 11 illustrates a visualization display including a data flow view updated based on a user's action and/or selection in FIG. 10 according to some embodiments.

FIG. 12 illustrates a visualization display including a time line in accordance with some embodiments.

FIG. 13 illustrates a visualization display including a data flow view updated based on a user's time line adjustments according to some embodiments.

FIG. 14 illustrates a visualization display including more details about an event according to some embodiments.

FIG. 15 illustrates a visualization platform in accordance with some embodiments.

FIG. 16 is a tabular view of a portion of a meta information database in accordance with some embodiments of the present invention.

### DETAILED DESCRIPTION

Some embodiments disclosed herein facilitate a visualization of big data in such a way so as to improve a person's ability to interpret the big data efficiently and/or accurately. Some embodiments are associated with systems and/or computer-readable medium that may help perform such a method.

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

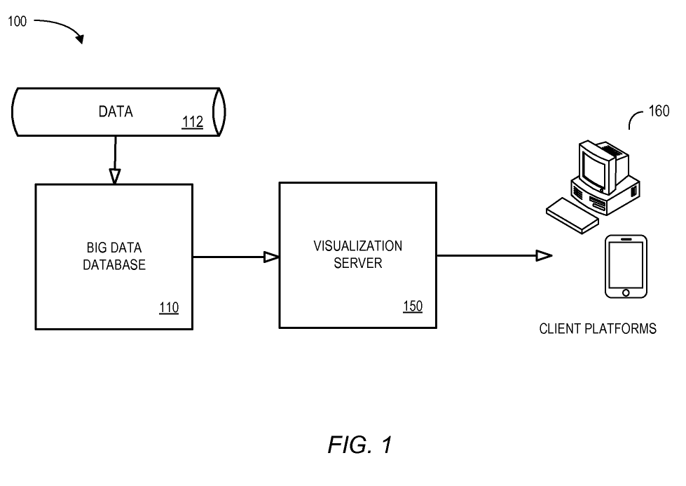

Some embodiments described herein may automatically facilitate a visualization of big data in such a way so as to improve a person's ability to interpret the data efficiency and/or accurately. For example, FIG. 1 is a block diagram of a system 100 that may be associated with any of the embodiments described herein. In particular, the system 100 includes a visualization server 150 that may access a big data database 110 in communication with a substantial amount of data 112 (e.g., from multiple data sources and including different types of data). The big data database 110 may periodically update (e.g., on a daily basis) information about financial performance of an enterprise, parameter values, metadata, etc. The visualization server 150 may also communicate with a set of client platforms 160 that are used to view information. The client platforms 160 may, for example, be used to execute a web browser, smartphone application, etc. According to some embodiments, the visualization server 150 may use a Graphical User Interface (“GUI”) to render user displays for the client platforms 160.

As used herein, the phrase “big data” may refer to data sets so large and/or complex that traditional data processing applications may be inadequate (e.g., to perform appropriate analysis, capture, data curation, search, sharing, storage, transfer, visualization, and/or information privacy for the data). Analysis of big data may lead to new correlations, to spot business trends, prevent diseases, etc. Scientists, business executives, practitioners of media and advertising and governments alike regularly face difficulties with large data sets in areas including Internet search, finance and business informatics. Scientists encounter limitations in meteorology, genomics, complex physics simulations, biological and environmental research, etc.

Note that data sets may grow in size because they are increasingly gathered by cheap and/or numerous information-sensing mobile devices, aerial (remote sensing), software logs, cameras, microphones, Radio-Frequency Identification (“RFID”) readers, wireless sensor networks, etc.

Relational database management systems and desktop statistics and visualization packages may have difficulty handling big data. The work may instead be performed via parallel software running on multiple servers. Big data usually includes data sets with sizes beyond the ability of commonly used software tools to capture, curate, manage, and process data within a tolerable elapsed time. The visualization server 150 may provide information, such as user customized reports and/or displays based on information in the big data database 110.

The visualization server 150 and/or other devices within the system 100 might be, for example, associated with a Personal Computer (“PC”), laptop computer, smartphone, an enterprise server, a server farm, and/or a database or similar storage devices. The visualization server 150 may, according to some embodiments, be associated with an industrial asset enterprise.

According to some embodiments, an “automated” visualization server 150 may facilitate the collection and analysis of big data. For example, the visualization server 150 may automatically customize a display for a client platform 160. As used herein, the term “automated” may refer to, for example, actions that can be performed with little (or no) intervention by a human.

As used herein, devices, including those associated with the visualization server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The visualization server 150 may store information into and/or retrieve information from the big data database 110. The big data database 110 might be locally stored or reside remote from the visualization server 150. As will be described further below, the big data database 110 may be used by the visualization server 150 to facilitate a display of information to a user of one of the client platforms 160. According to some embodiments, the visualization server 150 communicates information associated with big data to a remote device and/or to an automated system, such as by transmitting an electronic file to a user device, an email server, a workflow management system, a predictive model, a map application, etc.

Although a single visualization server 150 is shown in FIG. 1, any number of such devices may be included. Moreover, various devices described herein might be combined according to embodiments of the present invention. For example, in some embodiments, the visualization server 150 and big data database 110 might be co-located and/or may comprise a single apparatus.

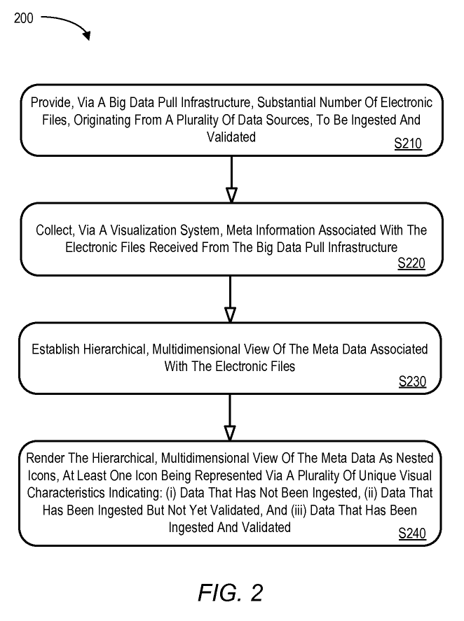

Note that the system 100 of FIG. 1 is provided only as an example, and embodiments may be associated with additional elements or components. According to some embodiments, the elements of the system 100 facilitate a visualization of big data in such a way so as to improve a person's ability to interpret the big data efficiently and/or accurately. Consider, for example, FIG. 2 which is a flow chart of a method 200 in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S210, a big data pull infrastructure may provide a substantial number of electronic files, originating from a plurality of data sources, to be ingested and validated. The files may contain, for example, financial information about an enterprise or any other type of big data. As used herein, the term “enterprise” might refer to, for example, a business or any other type of organization. At S220, a visualization system may collect meta information associated with the electronic files received from the big data pull infrastructure. At S230, a hierarchical, multidimensional view of the meta data associated with the electronic files may be established.

At S240, the hierarchical, multidimensional view of the meta data is rendered by the visualization system as nested icons, at least one icon being represented via a plurality of unique visual characteristics indicating: (i) data that has not been ingested, (ii) data that has been ingested but not yet validated, and (iii) data that has been ingested and validated. According to some embodiments, this rendering is dynamically performed in substantially real time, the big data pull infrastructure is associated with a parent enterprise, and the hierarchical view of the meta data includes a set of child units operating under the parent enterprise. Each child unit might represent, for example, an operating business of the parent enterprise.

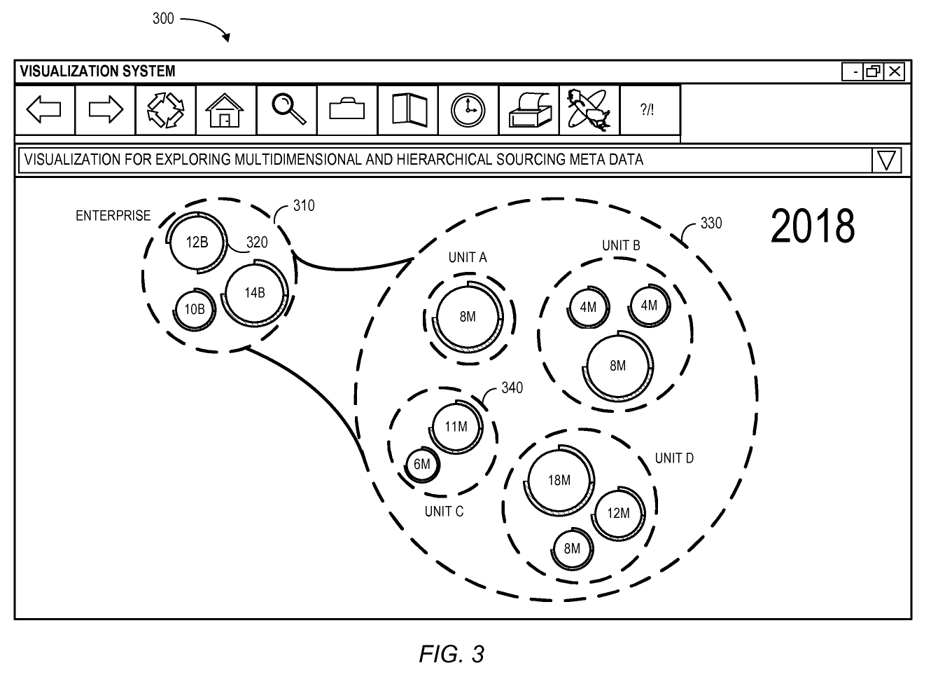

According to some embodiments, the multidimensional view of the meta data includes a plurality of operating parameters for each child unit. For example, FIG. 3 illustrates a visualization display 300 according to some embodiments. In this example, the display 300 includes a parent enterprise area 310 showing three operating parameters 320.

By way of example only, the operating parameters might be associated with: spend values, Cash Flow from Operating Activities (“CFOA”) values, and/or financial deflation values. Note that each operating parameter for the parent enterprise is visualized as a circular icon within a larger icon representing the parent enterprise. The display 300 also includes a child unit area 330 showing operating parameters for a number of different child units 340 (i.e., units A through D) and each operating parameter for a child unit 340 is visualized as a circular icon within a larger circular icon representing that child unit. According to some embodiments, sizes of operating parameter circular icons are associated with magnitudes of values of associated operating parameters. For example, a circle representing 8,000,000 (“8M”) may be larger as compared to a circle representing 4,000,000 (“4M”). In the example of FIG. 3, “14 B” might refer to 14 billion dollars, 14 billion data items, etc. Similarly, “6M” might refer to 6 million transactions, 6 million data elements, etc.

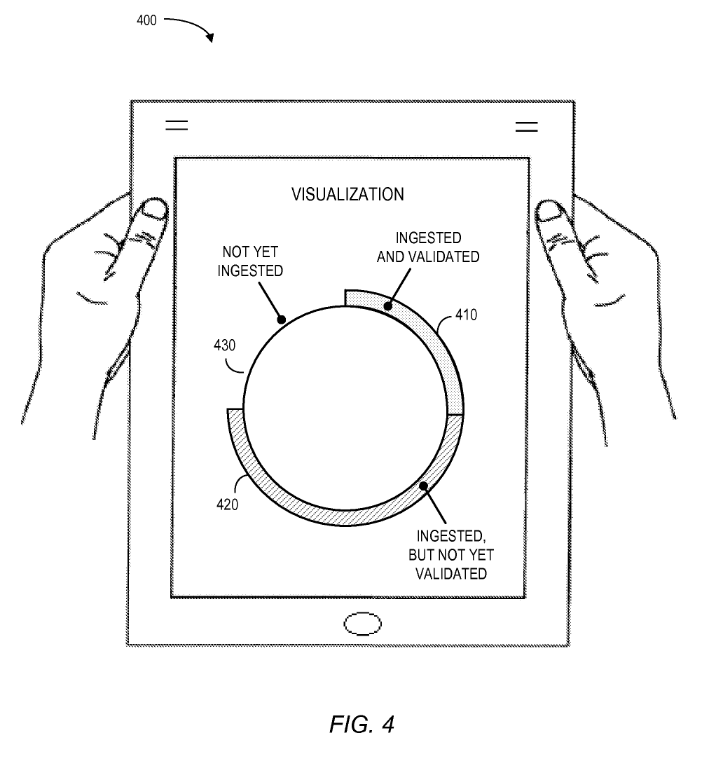

According to some embodiments, at least one icon is represented via a plurality of unique “visual characteristics” indicating: (i) data that has not been ingested, (ii) data that has been ingested but not yet validated, and (iii) data that has been ingested and validated. According to some embodiments, a “visual characteristic” may be associated with a perimeter line type, a perimeter line color, a perimeter line thickness, and/or a perimeter line animation (e.g., a portion of the perimeter line that flashes on and off). For example, FIG. 4 illustrates visual characteristics on a tablet display 400 in accordance with some embodiments. In this case, a grey visual characteristic 410 indicates data that has been ingested and validated (approximately 25% in the example of FIG. 4), a cross-hatched visual characteristic 420 indicates data that has been ingested but not yet validated (approximately 50% in the example of FIG. 4), and a thin visual characteristic 430 indicates data that has not been ingested yet (approximately 25% in the example of FIG. 4).

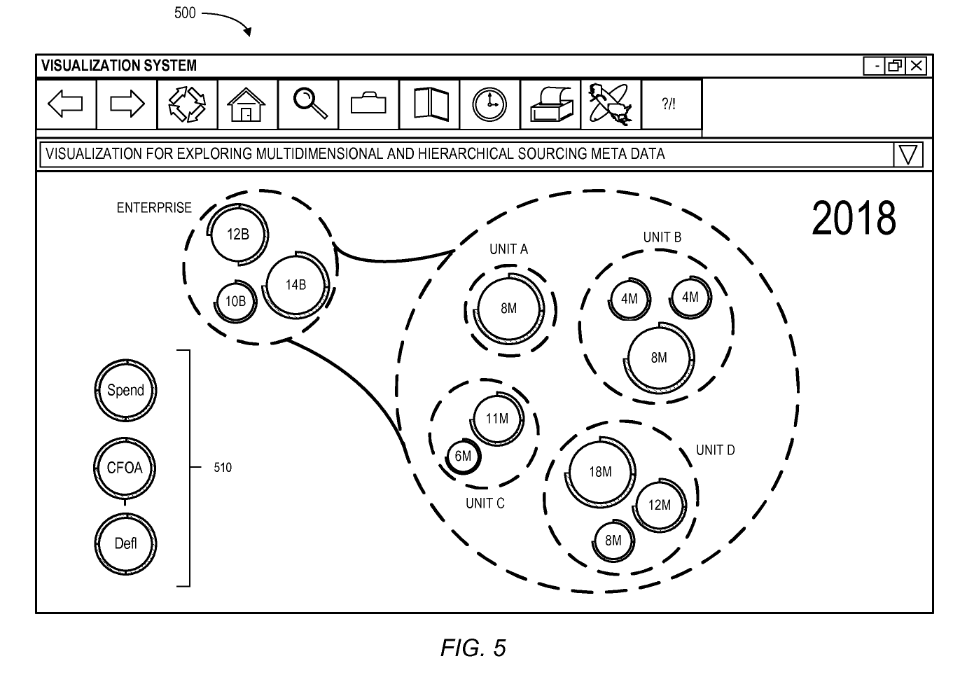

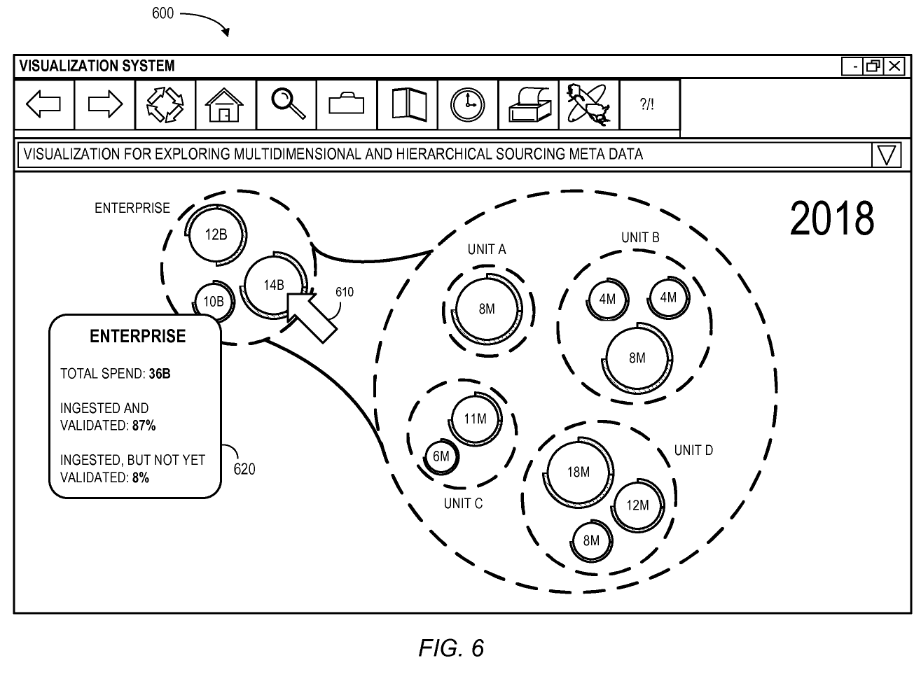

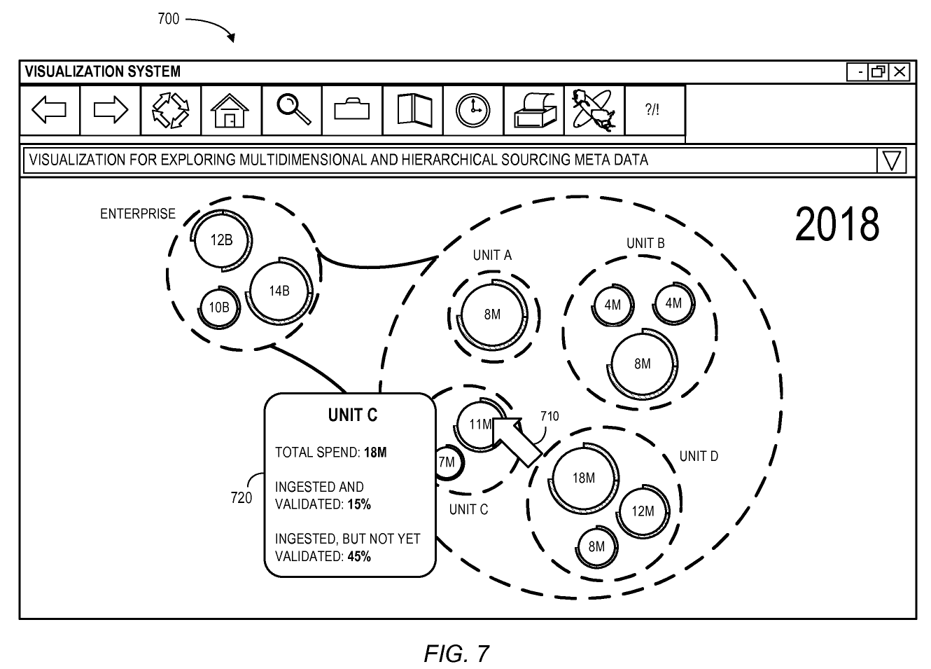

FIG. 5 illustrates a visualization display 500 with a legend 510 according to some embodiments. The legend 510 may help a user understand the symbols displayed in connection with the parent enterprise and/or the child units (e.g., as representing spending, CFOA, deflation, etc.). FIG. 6 illustrates a visualization display 600 including more detailed parent enterprise-level information in accordance with some embodiments. In particular, a computer pointer 610 hovers over an operating parameter for the parent enterprise. As a result, a pop-up display 620 provides more detailed information about that parameter. Similarly, movement of a computer pointer over a circular icon of an operating parameter of a child unit results in a pop-up display containing details about that operating parameter for the child unit. For example, FIG. 7 illustrates a visualization display 700 including more detailed child unit-level information according to some embodiments. In this case, a computer pointer 710 hovers over an operating parameter of a child unit and, as a result, a pop-up display 720 provides more detailed information about that parameter.

Thus, embodiments may provide methods, systems, and user interfaces to support a highly interactive application for the exploration of sourcing data available in a data lake. As used herein, the phrase “data lake” may refer to a massive, easily-accessible data repository that stores “big data” from several business entities within a large organization (or any other type of hierarchical data). Embodiments may provide a system to collect meta information about sourcing data while supporting an interactive user interface for exploring this meta-information. The collected meta information may be multidimensional and hierarchical in nature based on different businesses and sub-business (or any other type of organized data structures) and let users quickly slice and dice the multidimensional hierarchical data using a circular visualization.

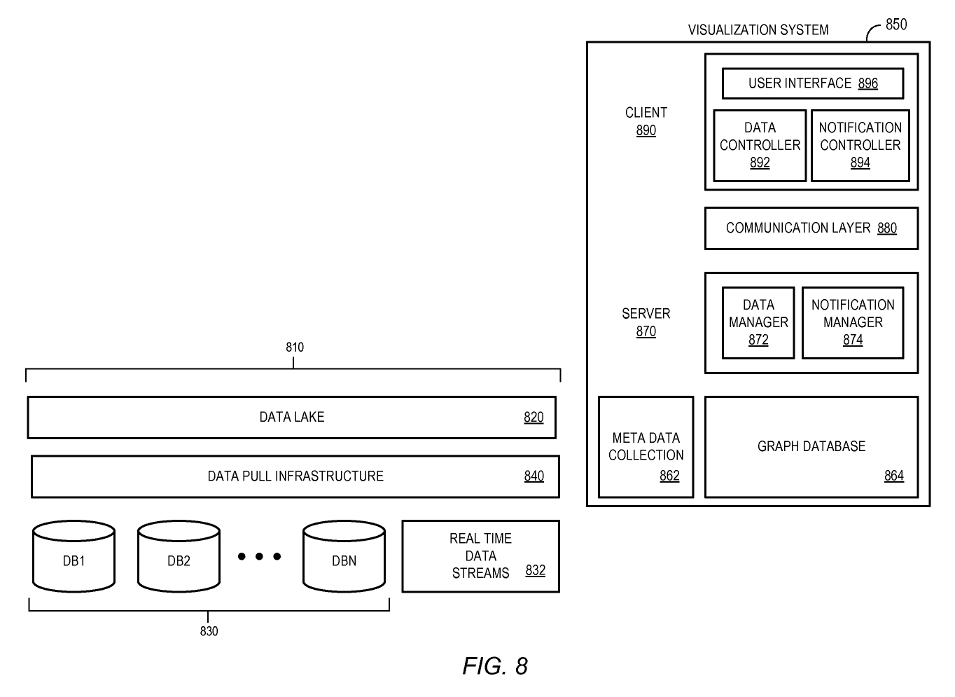

Note that different building blocks of a proposed system, along with an existing data-lake infrastructure, may be used to create a visualization system. For example, FIG. 8 is a block diagram of a system architecture 800 that may be associated with any of the embodiments described herein. Information 810 from a number of different sources, such as a data lake 820, databases DB/through DBN 830, and/or real time data streams 832 may be provided to a visualization system 500. Information, the system 500 includes a meta data collection 862 that collects relevant meta-information while supporting both manual and automatic input mediums and a graph database 864 that store the meta data for easy user access and manipulation. A server side 870 may host a web-based UI application, provide the ability to support multiple users simultaneously, and relay notifications and data updates in substantially real time (e.g., via a data manager 872 and a notification manager 874). On the other side of a communication layer 860, a client side 890 may host an interactive web-based application (user interface 896) that lets a user explore the underlying information and meta-information about available data inventory in data-lake (e.g., via a data controller 892 and a notification controller 894).

When the user interface 896 application is loaded, the user may see both an enterprise-wide overview and summaries by individual child units (e.g., businesses) represented as bubbles or circular icons. The size of labels may also be relative to the value of each child unit or business. According to some embodiments, clicking on a business bubble icon may take a user to another next level (e.g., which visualizes suppliers of each business). This next level may follow in the same fashion as the first level of the display. If a user wants to go back to the upper level, he or she might simply click the bubble icon of the business (e.g., Unit B) to return to enterprise-level display.

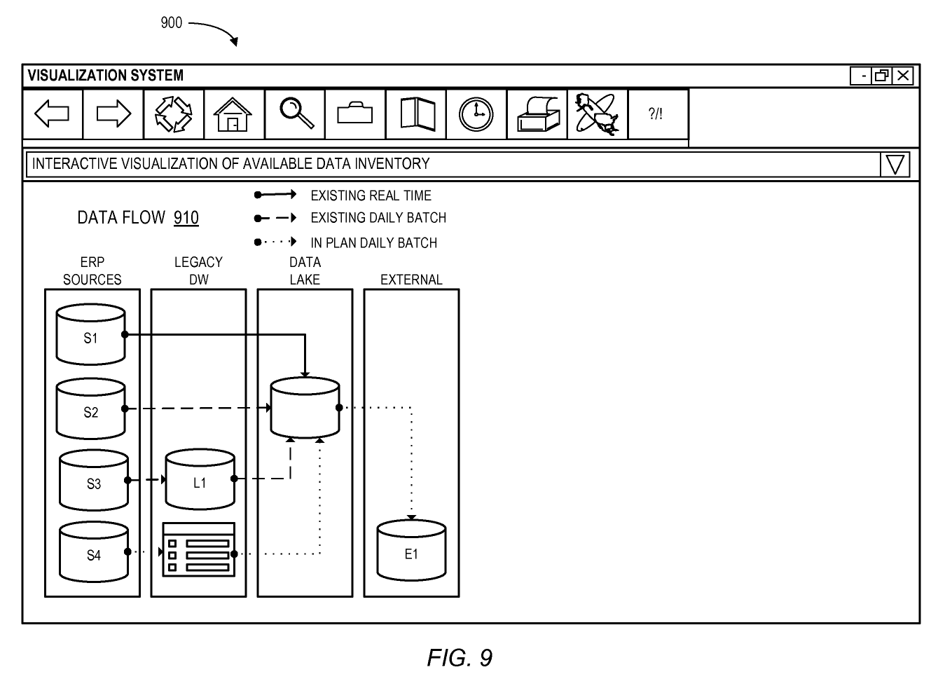

Note that FIGS. 3 through 7 are provided only as examples, and could represent displays that are most appropriate for a high-level manager. In some cases, more detailed information about big data might be desired (e.g., by an IT professional). FIG. 9 illustrates a visualization display 900 including a data flow view 910 according to some embodiments. As before, a big data pull infrastructure may provide a substantial number of electronic files, originating from a plurality of data sources, and a visualization system may collect meta information associated with the electronic files received from the big data pull infrastructure. In this display 900, the data flow view 910 is rendered graphically to indicate flows of information from data sources to data destinations. The data sources or data destinations might include, for example, Enterprise Resource Planning (“ERP”) data elements, legacy Data Warehouse (“DW”) data elements, data lake elements, and/or external elements. Note that the rendering of the data flow view 910 may be dynamically performed in substantially real time and the flows of information may represented via a plurality of unique characteristics representing: validation data, existing real time data, existing daily batch data, “in plan” real time data (real time data that is scheduled to be moved in the future), and/or “in plan” daily batch data (batch data that is scheduled to be moved in the future). The characteristic might be associated with, for example, a line type, a line color, a line thickness, and/or a line animation.

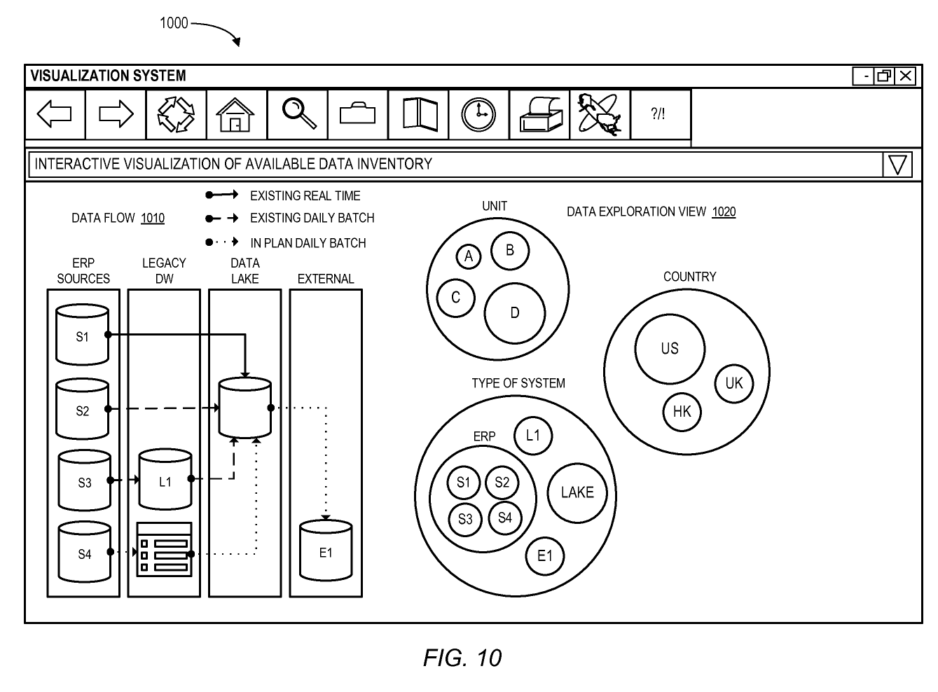

In addition to a data flow view, some embodiments may provide a data exploration view to graphically indicate a plurality of category icons, each icon representing a different type of data category, wherein nested sub-category icons are displayed within each category icon. For example, FIG. 10 illustrates a visualization display 1000 including a data flow view 101 and a data exploration 1020 view in accordance with some embodiments. Note that each sub-category icon may visualized as a circular icon within a larger circular icon representing the data category 9 (e.g., unit, country, and type of system in the example of FIG. 10) and sizes of sub-category circular icons may be associated with magnitudes of values of associated sub-categories (e.g., the size of the “US” circle in the country category is larger than the size of the “UK” circle). Similarly, sizes of category circular icons may be associated with magnitudes of values of associated categories.

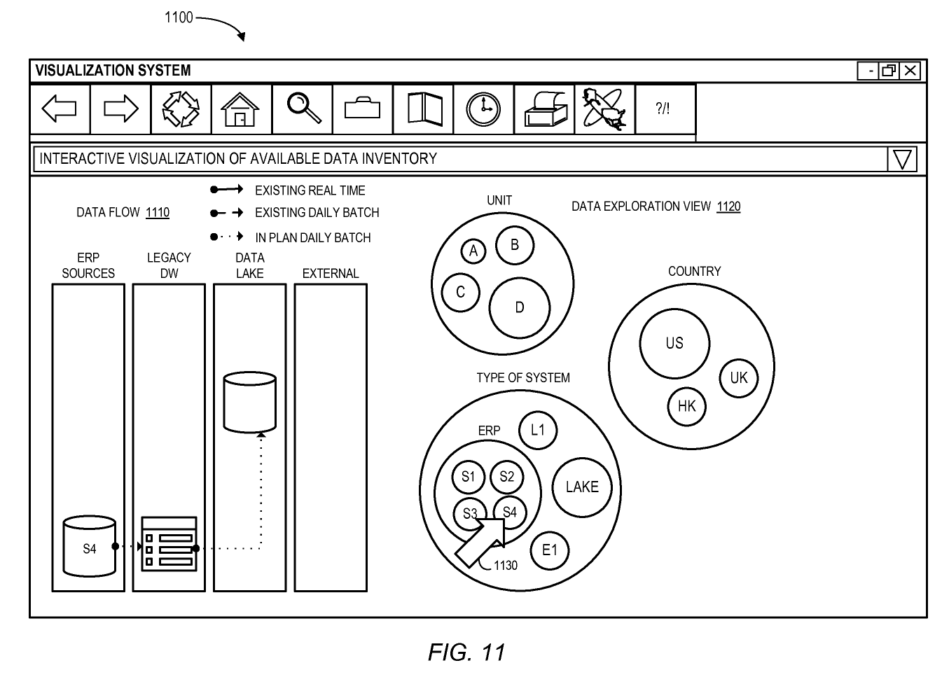

According to some embodiments, movement of a computer pointer over a circular icon of sub-category may result in a real time update of the data flow view such that only flows of information from data sources to data destinations associated with that sub-category are rendered. For example, FIG. 11 illustrates a visualization display 1100 including a data exploration view 1120 and an updated data flow view 1110 according to some embodiments. In particular, a computer pointer 1130 has selected source “S4” and, as a result, the data flow view 1110 has been updated to only show information about that source.

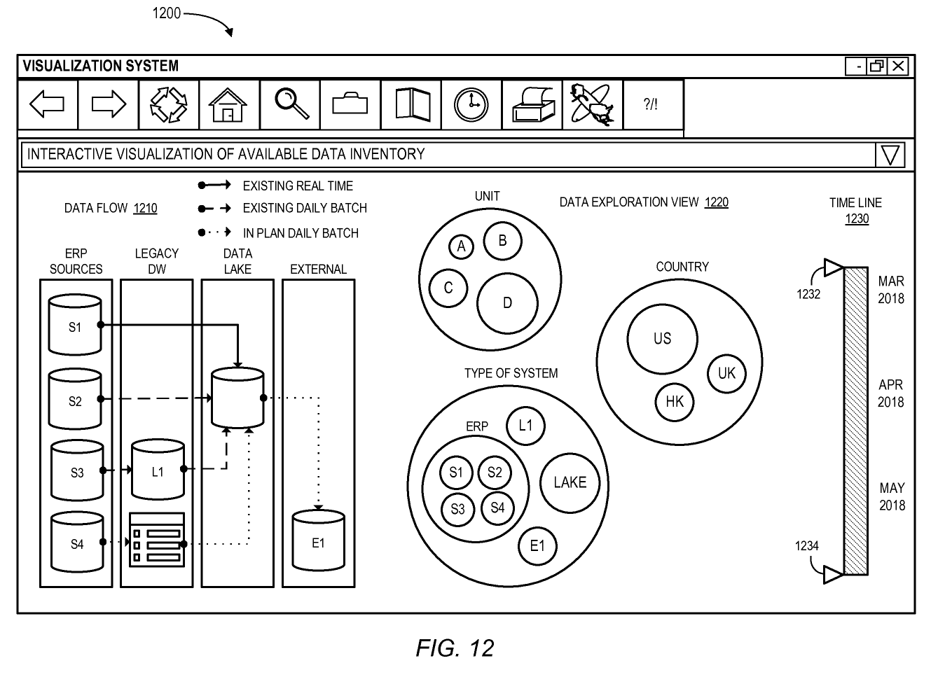

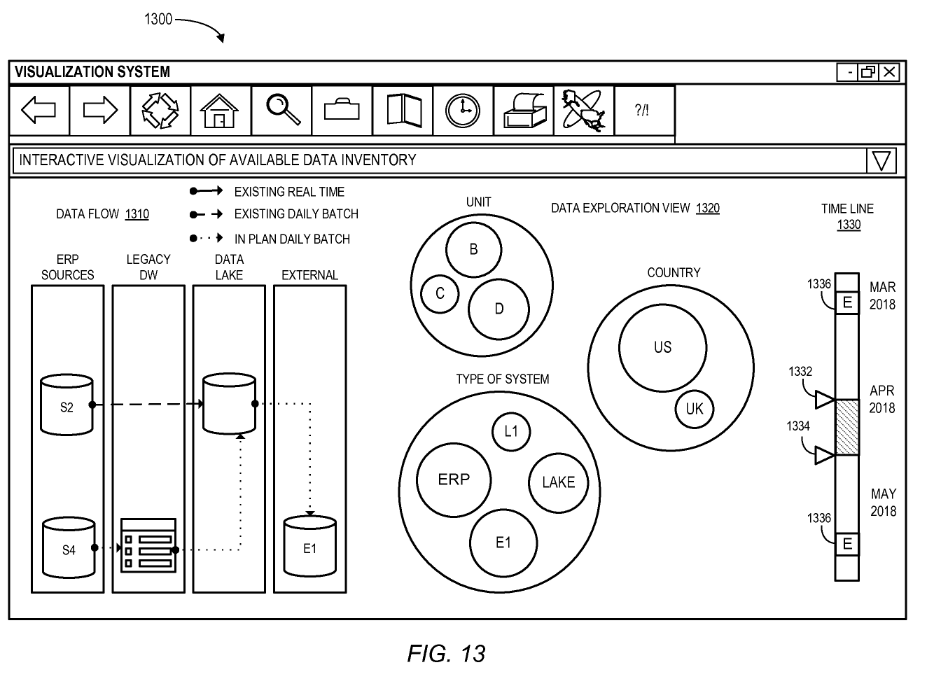

According to some embodiments, a time line may be rendered graphically to indicate a period of time. For example, FIG. 12 illustrates a visualization display 1200 including a data flow view 1210, a data exploration view 1220, and a time line 1230 in accordance with some embodiments. The timeline 1230 includes a start anchor icon 1232 and an end anchor icon 1324. According to some embodiments, movement of one of the start anchor icon 1222 and end anchor icon 1224 may dynamically update the data flow view such that only flows of information from data sources to data destinations associated with a time period from the start anchor icon 1222 to the end anchor icon 1224 are rendered. For example, FIG. 13 illustrates a visualization display 1300 including a data flow view 1310, a data exploration view 1320, and a time line 1330. In this example, the start anchor icon 1332 and the end anchor icon 1334 may be moved defining a new “window of time” (illustrated with cross-hatching in FIG. 13). The data flow view 1310 may then be dynamically updated to reflect information within that window according to some embodiments. Similarly, the data exploration view 1320 may be dynamically updated such that only category icons and nested sub-category icons associated with a time period from the start anchor icon 13323 to the end anchor icon 1334 are rendered.

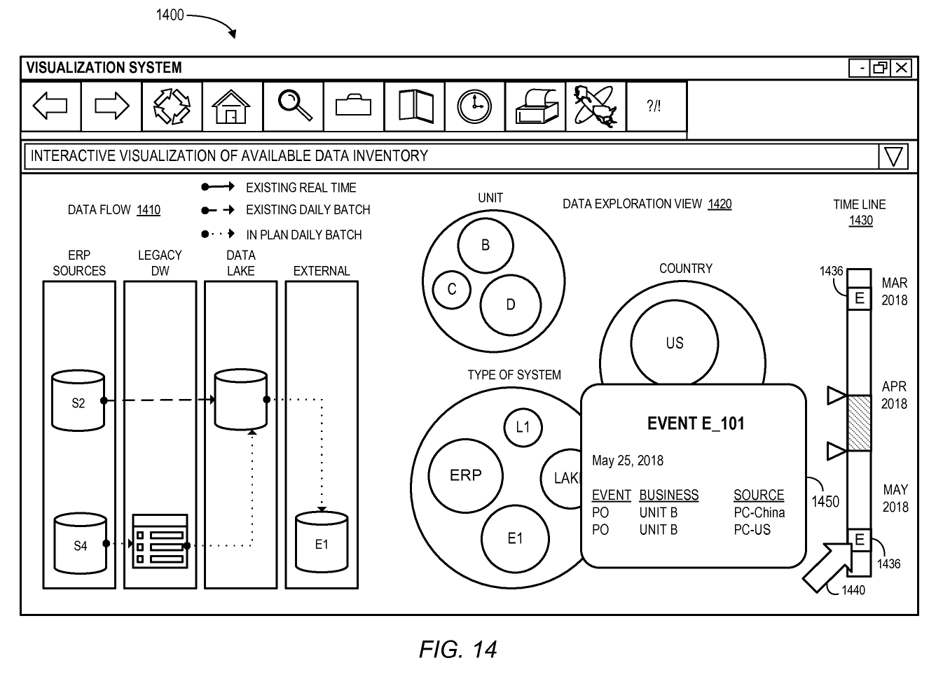

According to some embodiments, the time line 1330 includes one or more graphical items associated with Events (“E”) that may occur in the system. For example, two events 1336 are illustrated in the time line 1330 of FIG. 13. According to some embodiments, user selection of an event 1336 (e.g., by clicking on or hovering over an icon) may result in a display of more information about that event 1336. For example, FIG. 14 illustrates a visualization display 1400 including more details about an event according to some embodiments. The display 1400 includes a data flow view 1410, a data exploration view 1420, and a timeline 1430 having events 1436. In this example, a cursor 1440 is positioned over one of the events 1435 causing a pop-up window 1450 to be displayed containing more details about that event (e.g., an event name or identifier, an event date, a business associated with the event, an event source, etc.).

Thus, embodiments may provide tools, systems and processes to support a highly interactive application for the exploration of available data inventory in a data-lake. The invention may provide an innovative interactive UI and effective technological solutions for exploring available data inventory of data across multiple businesses (or other operating units). Such an approach may improve the effectiveness of a user's ability to quickly access available data in a data lake and increase the ease with which he or she can identify what is available (and when to expect additional data pulls into the data-lake). Note that embodiments may be particular helpful when data is pulled into the data-lake from different data stream (i.e., existing data sources and/or real-time data streams). Moreover, embodiments may let a user easily consume meta-information about the data inventory and let him or her quickly identify the status of available data in a data lake.

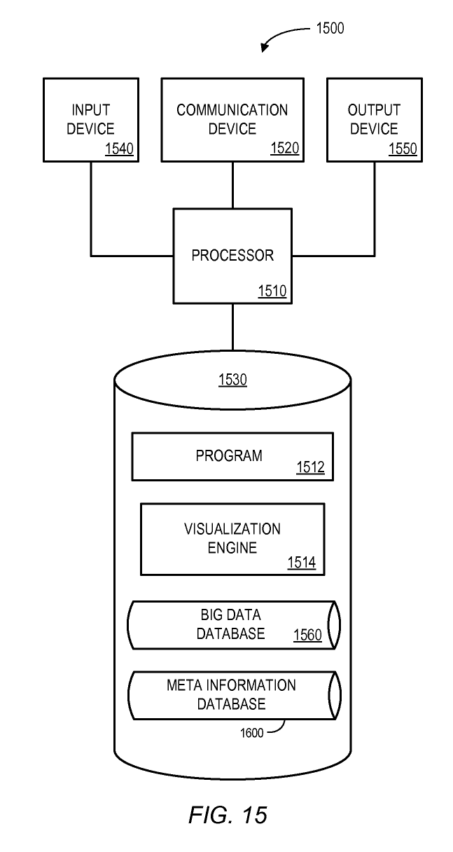

The embodiments described herein may be implemented using any number of different hardware configurations. For example, FIG. 15 illustrates an apparatus or platform 1500 that may be, for example, associated with the visualization server 160 of FIG. 1. The apparatus 1500 comprises a processor 1510, such as one or more commercially available Central Processing Units (“CPUs”) in the form of one-chip microprocessors, coupled to a communication device 1520 configured to communicate via a communication network (not shown in FIG. 15). The apparatus 1500 further includes an input device 1540 (e.g., a mouse and/or keyboard to enter information about financial structures, user display preferences, etc.) and an output device 1550 (e.g., a computer monitor to output data visualizations and reports).

The processor 1510 also communicates with a storage device 1530. The storage device 1530 may comprise any appropriate information storage device, including combinations of magnetic storage devices (e.g., a hard disk drive), optical storage devices, mobile telephones, and/or semiconductor memory devices. The storage device 1530 stores a program 1512 and/or a visualization engine 1514 for controlling the processor 1510. The processor 1510 performs instructions of the programs 1512, 1514, and thereby operates in accordance with any of the embodiments described herein. For example, the processor 1510 might arrange for a big data pull infrastructure to provide a substantial number of electronic files, originating from a plurality of data sources, to be ingested and validated. The processor 1510 may collect meta information associated with the electronic files received from the big data pull infrastructure. According to some embodiments, a hierarchical, multidimensional view of the meta data associated with the electronic files may be established by the processor 1510. Moreover, the hierarchical, multidimensional view of the meta data may be rendered by the processor 1510 as nested icons, at least one icon being represented via a plurality of unique visual characteristics indicating: (i) data that has not been ingested, (ii) data that has been ingested but not yet validated, and (iii) data that has been ingested and validated.

The programs 1512, 1514 may be stored in a compressed, uncompiled and/or encrypted format. The programs 1512, 1514 may furthermore include other program elements, such as an operating system, a database management system, and/or device drivers used by the processor 1510 to interface with peripheral devices.

As used herein, information may be “received” by or “transmitted” to, for example: (i) the apparatus 1500 from another device; or (ii) a software application or module within the apparatus 1500 from another software application, module, or any other source.

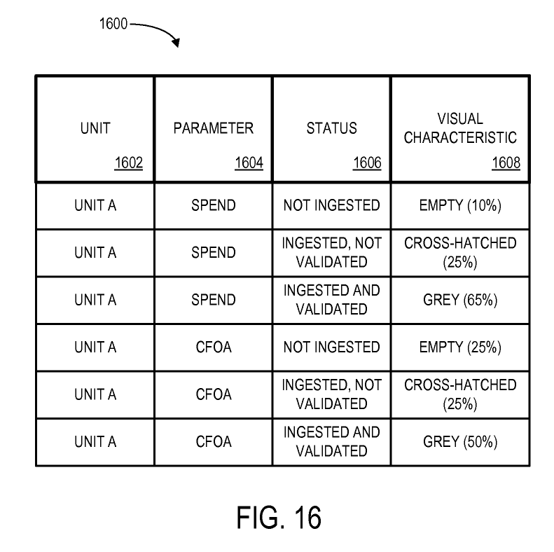

As shown in FIG. 15, the storage device 1530 also stores a big data database 1560 and a meta information database 1600. One example of a meta information database 1600 that may be used in connection with the apparatus 1500 will now be described in detail with respect to FIG. 16. The illustration and accompanying descriptions of the database presented herein is exemplary, and any number of other database arrangements could be employed besides those suggested by the figures.

FIG. 16 is a tabular view of a meta information database 1600 in accordance with some embodiments of the present invention. The table includes entries associated with a visualization display. The table also defines fields 1602, 1604, 1606, 1608 for each of the entries. The fields specify: a unit 1602, a parameter 1604, a status 1606, and meta information 1608. The information in the database 1600 may be periodically created and updated based on information collected during operation of an enterprise (e.g., a parent of the units 1602 in the database 1600).

The unit 1602 might be a unique alphanumeric code identifying 1602 a child unit operating under a parent enterprise, and the parameter 1604 might describe a type of value being tracked for the unit 1602. The status 1606 might indicate the current status of the data for the parameter 1604 (on a per-unit 1602 basis) and the meta information 1608 may adjust, for example, how a portion of the perimeter of a circular icon might be displayed to reflect that status 1606. In the example, of FIG. 16, the 25% of the perimeter of a “spend” circular icon for unit A will be displayed as cross-hatched indicating that the 25% of spend data files have been ingested but have not yet been verified.

Thus, some embodiments described herein may facilitate a visualization of big data in such a way so as to improve a person's ability to interpret the big data efficiently and/or accurately.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with financial management systems, although embodiments may be used in connection other any other type of information (industrial assets, artificial intelligence, etc.).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a big data pull infrastructure adapted to provide a substantial number of electronic files, originating from a plurality of data sources, to be ingested and validated; and
a visualization system to collect meta information associated with the electronic files received from the big data pull infrastructure, wherein:
a hierarchical, multidimensional view of the meta data associated with the electronic files is established, and
the hierarchical, multidimensional view of the meta data is rendered by the visualization system as nested icons, at least one icon being represented via a plurality of unique visual characteristics indicating: (i) data that has not been ingested, (ii) data that has been ingested but not yet validated, and (iii) data that has been ingested and validated.

2. The system of claim 1, wherein said rendering is dynamically performed in substantially real time, the big data pull infrastructure is associated with a parent enterprise, and the hierarchical view of the meta data includes a set of child units operating under the parent enterprise.

3. The system of claim 2, wherein each child unit represents a business of the parent enterprise.

4. The system of claim 2, wherein the multidimensional view of the meta data includes a plurality of operating parameters for each child unit.

5. The system of claim 4, wherein at least one operating parameter is associated with: (i) spend values, (ii) cash flow from operating activities values, or (iii) financial deflation values.

6. The system of claim 4, wherein each operating parameter for the parent enterprise is visualized as a circular icon within a larger icon representing the parent enterprise.

7. The system of claim 6, wherein for each child unit:
each operating parameter for that child unit is visualized as a circular icon within a larger circular icon representing that child unit.

8. The system of claim 7, wherein sizes of operating parameter circular icons are associated with magnitudes of values of associated operating parameters.

9. The system of claim 7, wherein at least one visual characteristic comprises: (i) a perimeter line type, (ii) a perimeter line color, (iii) a perimeter line thickness, or (iv) a perimeter line animation.

10. The system of claim 7, wherein movement of a computer pointer over a circular icon of an operating parameter of the parent enterprise results in a pop-up display containing details about that operating parameter for the parent enterprise.

11. The system of claim 7, wherein movement of a computer pointer over a circular icon of an operating parameter of a child unit results in a pop-up display containing details about that operating parameter for that child unit.

12. A system, comprising:
a big data pull infrastructure adapted to provide a substantial number of electronic files, originating from a plurality of data sources; and
a visualization system to collect meta information associated with the electronic files received from the big data pull infrastructure, wherein:
a data flow view is rendered graphically indicating flows of information from data sources to data destinations, and
a data exploration view is rendered to graphically indicate a plurality of category icons, each icon representing a different type of data category, wherein nested sub-category icons are displayed within each category icon.

13. The system of claim 12, wherein the data sources or data destinations include at least one of: (i) enterprise resource planning data elements, (ii) legacy data warehouse data elements, (iii) data lake elements, and (iv) external elements.

14. The system of claim 12, wherein the rendering is dynamically performed in substantially real time and the flows of information are represented via a plurality of unique characteristics representing: (i) validation data, (ii) existing real time data, (iii) existing daily batch data, (iv) in plan real time data, and (v) in plan daily batch data.

15. The system of claim 12, wherein each sub-category icon is visualized as a circular icon within a larger circular icon representing the data category and sizes of sub-category circular icons are associated with magnitudes of values of associated sub-categories.

16. The system of claim 15, wherein sizes of category circular icons are associated with magnitudes of values of associated categories.

17. The system of claim 12, wherein movement of a computer pointer over a circular icon of sub-category results in a real time update of the data flow view such that only flows of information from data sources to data destinations associated with that sub-category are rendered.

18. The system of claim 12, wherein a time line is rendered graphically indicating a period of time, including a start anchor icon and an end anchor icon.

19. The system of claim 18, wherein movement of one of the start anchor icon and end anchor icon dynamically updates the data flow view such that only flows of information from data sources to data destinations associated with a time period from the start anchor icon to the end anchor icon are rendered.

20. The system of claim 18, wherein movement of one of the start anchor icon and end anchor icon dynamically updates the data exploration view such that only category icons and nested sub-category icons associated with a time period from the start anchor icon to the end anchor icon are rendered.
